(19) United States
(12) Patent Application Publication
(10) Pub. No.: US 2007/0162604 A1
(43) Pub. Date: Jul. 12, 2007

(54) Information processing method, information processing device, and program

(76) Inventors: Nobuyuki Murakami, Yokohama (JP); Akihito Itou, Yokohama (JP); Shusuke Hamada, Yokohama (JP); Yusuke Komamiya, Machida (JP); Kazuma Kurata, Tokyo (JP); Yosuke Yokota, Kawasaki (JP); Yasuyuki Mogi, Yokohama (JP); Sachiko Sawamura, Kawasaki (JP); Daizou Sasayama, Yokohama (JP); Chigusa Matsui, Yokohama (JP); Hideo Ishii, Tokyo (JP); Kazuo Yamagami, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/474,338

(22) Filed: Jun. 26, 2006

(30) Foreign Application Priority Data
Jan. 6, 2006 (JP) 2006-001332

(51) Int. Cl. G06F 15/173

(52) U.S. Cl. 709/226

(57) ABSTRACT

An information processing device, which is communicably connected to a client device used by a user and each of a plurality of server devices to perform information processing for a service, stores on a memory server identification information for identifying the server device to perform the information processing, for each of a series of the information processing required to provide the service, with regards to each of the services. Then, the information processing device receives a message including service identification information for identifying the service, which is sent from the client device, identifies the service based on the service identification information included in the received message, reads out from the memory the server identification information corresponding to the identified service, and sends an information processing request for requesting to perform the information processing, to each of the server devices identified based on the read out server identification information.

### CROSS-REFERENCE TO RELATED APPLICATIONS

The present application claims priority from Japanese Patent Application No. 2006-1332 filed on Jan. 6, 2006, which is herein incorporated by reference.

### FIELD OF THE INVENTION

The present invention relates to an information processing method, an information processing device, and a program.

### BACKGROUND OF THE INVENTION

In information processing systems of recent years, it is often the case that information processing is distributed among a plurality of servers. Japanese Patent Laid-Open No. 2004-070852 has disclosed a system in which a mechanism is provided for solving the difference of communication settings among server devices so that a client device can receive services from the server devices.

However, in conventional systems including the above-mentioned system, it is only a single server that can be defined corresponding to a parameter included in a communication request message sent from a client device. Therefore, it is difficult to have those systems handle a service request with a parameter meaning that a plurality of servers is required for that service.

### SUMMARY OF THE INVENTION

The present invention has been contrived in consideration of the above-mentioned circumstance. It is an object of the present invention to provide an information processing method, an information processing device, and a program with which it becomes possible to instruct a plurality of servers to perform information processing.

According to an information processing method of the present invention, a message sent from a client device is analyzed to identify the requested service, and a command to perform necessary information processing is sent to each server device corresponding to the identified service.

In the above-mentioned information processing method, it is preferable that, when the command is sent to the server device, sending is performed following a pre-defined communication method.

It is also preferable that, upon receiving a response message sent from the server device which received the command, another command is sent to the other server.

It is also preferable that, with regards to a value of a data item included in the message, the service is identified based on a condition which corresponds to item information indicating that data item and matches the value of that data item, with use of information stored on a memory.

It is also preferable that, with regards to the value of the data item included in the response message which the server device sends upon receiving the command, the service is identified based on the condition which corresponds to the item information indicating that data item and matches the value of that data item.

It is also preferable that, a plurality of the response messages sent from the server devices which respectively received the commands regarding to the message, are received and collectively processed.

It is also preferable that, an input is accepted, with regards to information processing management data including information indicating the processing of the service, and information indicating the server device(s) required to perform the processing.

It is also preferable that, the input is accepted with regards to the above-mentioned information processing management data, by receiving the data sent from the client device.

An information processing device of the present invention receives a message sent from a client device, identifies the requested service, and sends a command to perform necessary information processing, to each server device corresponding to the identified service.

An information processing device of the present invention comprises a plurality of communication components, an information processing pattern table, a message receiving unit, a message processing unit, and a distribution processing unit.

A control program of the present invention causes an information processing device to execute steps of receiving a message sent from a client device, identifying the requested service, and sending a command to perform necessary information processing, to each server device corresponding to the identified service.

With aiming at accomplishment of the above-mentioned object, a main part of the present invention is an information processing method, executed by an information processing device which is communicably connected to a client device used by a user, and each of a plurality of server devices to perform information processing for a service, the information processing method comprising steps of:
storing, on a memory, server identification information which is used for identifying the server device to perform the information processing, for each of a series of the information processing required to provide the service, with regards to each of the services;
receiving a message including service identification information for identifying the service, which is sent from the client device; identifying the service based on the service identification information included in the received message, and reading out, from the memory, the server identification information corresponding to the identified service; and
sending an information processing request for requesting to perform the information processing, to each of the server devices identified based on the read out server identification information.

It is one of characteristics of the present invention that linking a plurality of servers can be performed without requiring modification of application programs.

According to the present invention, it becomes possible to instruct a plurality of servers to perform information processing.

### BRIEF DESCRIPTION OF THE DRAWINGS

FIG. 1 shows an overall configuration of an information processing system with regards to an embodiment of the present invention;

FIG. 2 shows a hardware configuration of a server linkage device 30;

FIG. 3 is a block diagram showing functions of the server linkage device 30;

FIG. 4 shows an example of a data configuration of a service-mapping table 351;

FIG. 5 shows an example of a data configuration of a linkage-pattern-management table 352;

FIG. 6 is a flow chart showing a process executed by the server linkage device 30;

FIG. 7 shows a specific example of the process executed by the server linkage device 30;

FIG. 8 is a flow chart showing a process of updating the service-mapping table 351 and the linkage-pattern-management table 352;

FIG. 9 shows an example of a screen 70 for use in the updating process illustrated in FIG. 8;

FIG. 10 illustrates a comparison between before-process and after-process when information processing required for a service is changed.

### DETAILED DESCRIPTION OF A PREFERRED EMBODIMENT

==System Configuration==

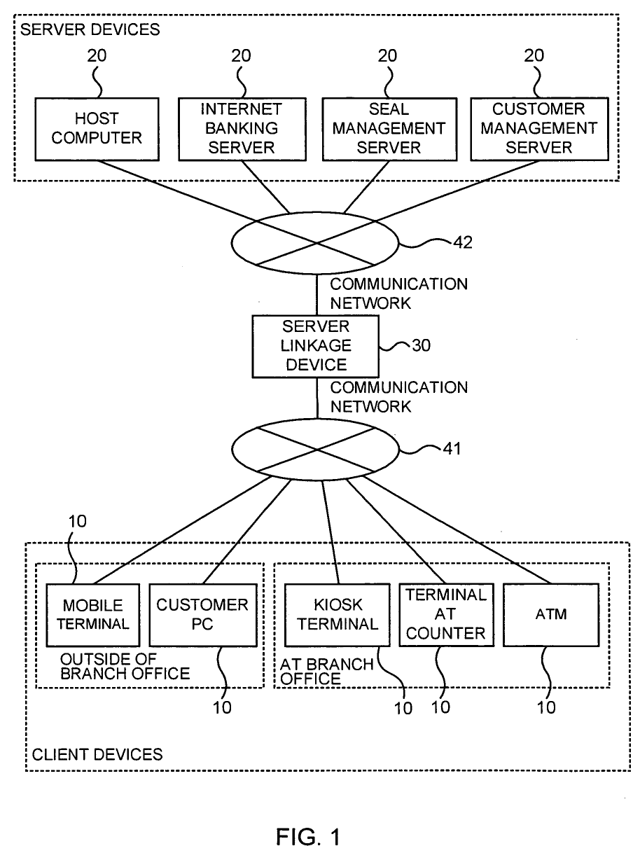

FIG. 1 shows an overall configuration of an information processing system including a server linkage device 30 (It corresponds to the information processing device of the present invention.), with regards to an embodiment of the present invention. As shown in FIG. 1, the information processing system of this embodiment comprises client devices 10, server devices 20, and the server linkage device 30. The server linkage device 30 is connected with the client devices 10 through a communication network 41, and with the server devices 20 through a communication network 42. The communication networks 41 and 42 respectively take the form of, for example, the Internet, LAN(Local Area Network), WAN(Wide Area Network), or another network, and are established with Ethernet(Registered Trademark), the public phone line, a frame relay net, or another method. The information processing system of this embodiment, for example, is assumed to be used in a financial institution.

The server devices 20 are computers to provide various information processing services. As each of the server devices 20, for example, a personal computer, a work station, or a general-purpose machine can be adopted. In this embodiment, as shown in FIG. 1, the server devices 20 are assumed to include a host computer 20 to manage customer's account information, an Internet banking server to provide a banking service via the Internet, a seal management server to manage customer's seal or signature information, and a customer management server to manage customer information.

The client devices 10 are computers to be used by customers, staffs at branch offices, or other users. As each of the client devices 10, for example, a personal computer, a workstation, a PDA(Personal Digital Assistant), or a mobile phone can be adopted. In this embodiment, as shown in FIG. 1, the client devices 20 are assumed to include a mobile terminal 10 and a personal computer (customer PC) 10 which are used by a customer at home or on the street, wherever outside of a branch office, and a kiosk terminal 10 and an ATM machine 10 which are used by a customer at a branch office, and a terminal at a counter 10 which is used by staff at a branch office.

The server linkage device 30 is a computer to transfer data sent from a client device 10 to a server device 20. As the server linkage device 30, for example, a personal computer, or a workstation can be adopted. In the following, the configuration of the server linkage device 30 is described in detail.

==Hardware Configuration of Server Linkage Device 30==

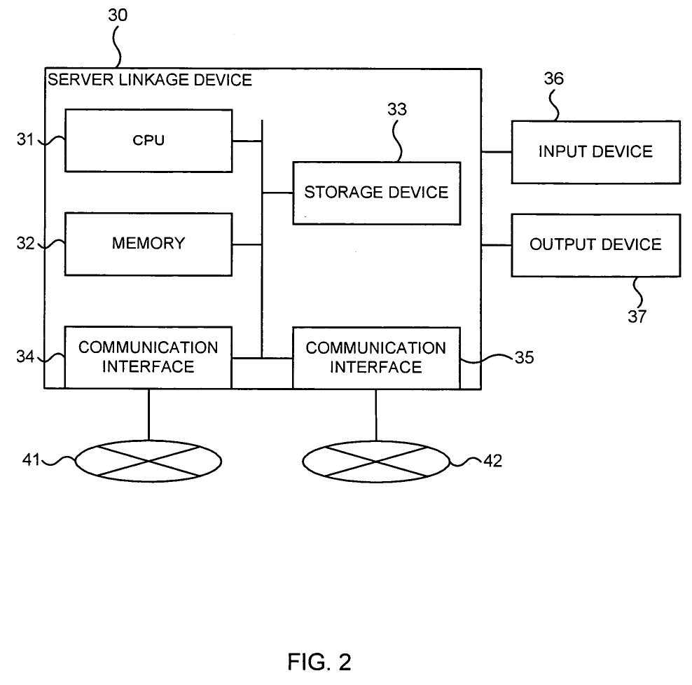

FIG. 2 shows a hardware configuration of the server linkage device 30. As shown in FIG. 2, the server linkage device 30 comprises a CPU 31, a memory 32, a storage device 33, communication interfaces 34 and 35, an input device 36, and an output device 37. The storage device 33 is a device to store programs and data, such as a hard disk drive, a CD-ROM drive, or a flash disk. The CPU 31 reads out programs stored on the storage device 33 to the memory 32, and executes the programs to realize various functions. The communication interface 34 is an interface for use in connection to the communication network 41, while the communication interface 35 is an interface for use in connection to the communication network 42. The communication interfaces 34 and 35, for example, take the form of Ethernet (Registered Trademark) adapters, or modems to access the public phone line. The input device 36, for example, takes the form of a keyboard or a mouse. The output device 37, for example, takes the form of a display or a printer.

==Software Configuration of Server Linkage Device 30==

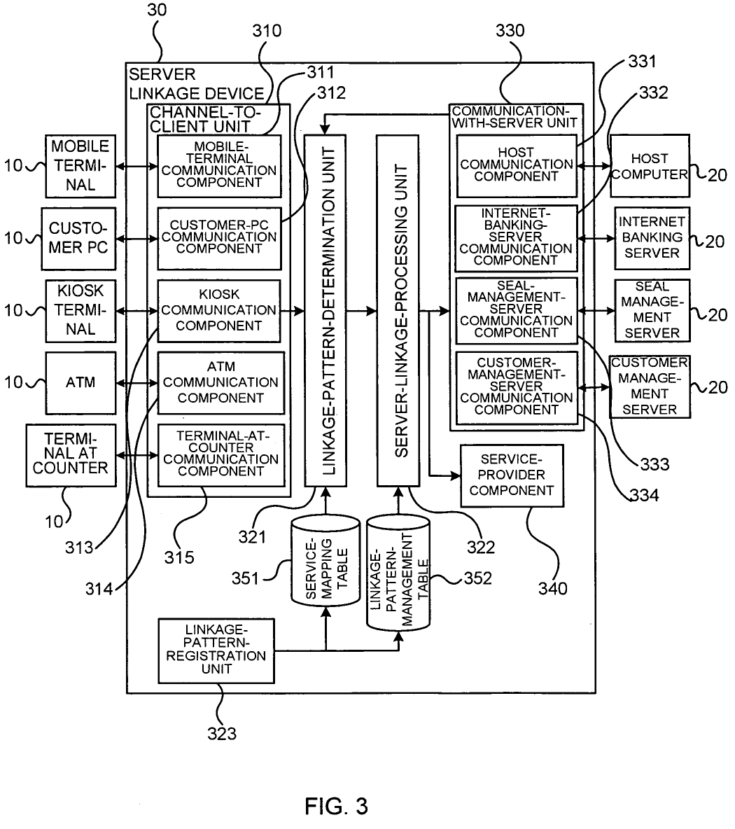

FIG. 3 is a block diagram showing functions of the server linkage device 30. As shown in FIG. 3, the server linkage device 30 comprises a channel-to-client unit 310, a linkage-pattern-determination unit 321, a server-linkage-processing unit 322, a linkage-pattern-registration unit 323, a communication-with-server unit 330, a service-provider component 340, a service-mapping table 351, and a linkage-pattern-management table 352.

The channel-to-client unit 310 is responsible for communications with the client devices 10. The channel-to-client unit 310 receives from a client device 10 a message which requests information processing with regard to a service (This message is hereinafter referred to as information processing request.), takes the received information processing request as an argument, and calls the linkage-pattern-determination unit 321, which is described later. In addition, the channel-to-client unit 310 transfers a response from the linkage-pattern-determination unit 321 to the client unit 10.

The channel-to-client unit 310 includes communication components (or modules) corresponding to respective types of the client devices 10. In this embodiment, the channel-to-client unit 310 is assumed to include a mobile-terminal communication component 311 for use in communication with the mobile terminal 10, a customer-PC communication component 312 for use in communication with the customer PC 10, a kiosk communication component 313 for use in communication with the kiosk terminal 10, an ATM communication component for use in communication with the ATM terminal 10, and a terminal-at-counter communication component 315 for use in communication with the terminal at a counter 10.

The communication-with-server unit 330 is responsible for communications with the server devices 20, and transfers the information processing request to the corresponding server device 20. The communication-with-server unit 330 includes communication components corresponding to respective types of the server devices 20. In this embodiment, the communication-with-server unit 330 is assumed to include a host communication component for use in communication with the host computer 20, an Internet-banking-server communication component for use in communication with the Internet banking server 20, a seal-management-server communication component 333 for use in communication with the seal management server 20, and a customer-management-server communication component 334 for use in communication with the customer management server 20.

With being provided a communication component for each of the server devices 20 in this way, every component in the server linkage device 30 can communicate with the server devices 20 without caring the difference of communication settings such as protocols among the server devices 20.

The service-provider component 340 is responsible for performing information processing which the server linkage device 30 itself provides.

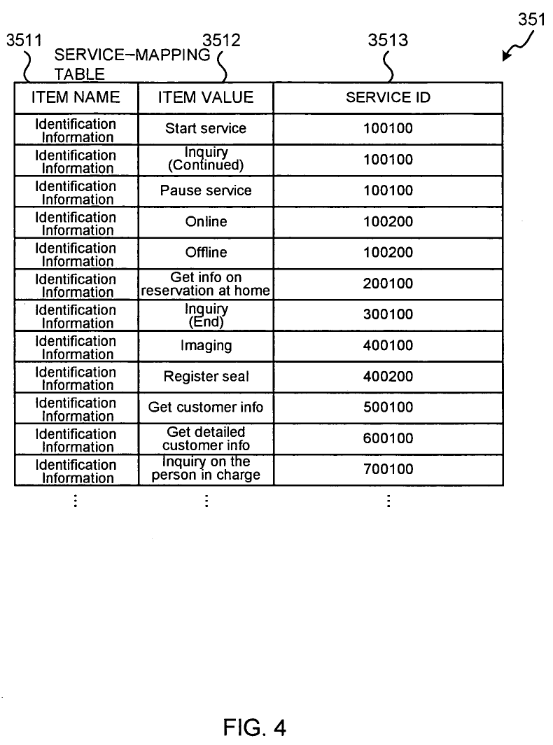

The service-mapping table 351 stores information which is used for identifying a service (This information is hereinafter referred to as service ID.), associating it with conditional information, to which a data item included in an information processing request is compared. FIG. 4 shows an example of a data configuration of the service-mapping table 351. As shown in FIG. 4, the service-mapping table 351 stores a service ID 3513, an item name 3511 which indicates a data item included in an information processing request, and an item value 3512, associating each data with the others. The item name 3511 and the item value 3512 are conditional information to which a data item included in an information processing request is compared.

The linkage-pattern-determination unit 321 obtains from the service-mapping table 351 the service ID corresponding to a data item included in an information processing request which the channel-to-client unit 310 receives from a client device 10, and determines the service ID representing the service to that request, and then takes the determined service ID and the information processing request as arguments, and calls the server-linkage-processing unit 322, which is described later. In addition, the linkage-pattern-determination unit 321 transfers a response from the server-linkage-processing unit 322 to the channel-to-client unit 310.

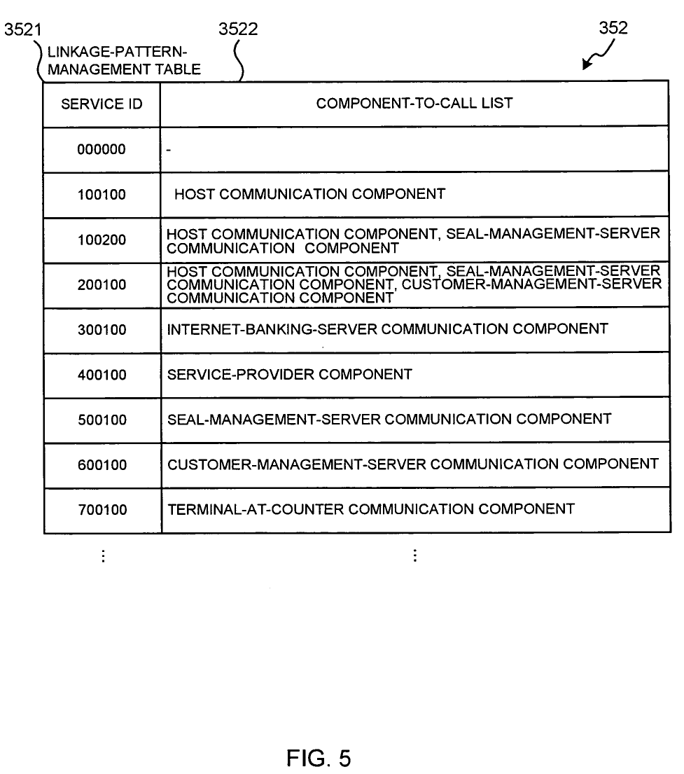

The linkage-pattern-management table 352 (It corresponds to the information processing pattern table of the present invention.) stores a list of components responsible for information processing required to provide a service, for each of services. (This list corresponds to the server identification information of the present invention. In this embodiment, not only the server devices 20 but also the client devices 10 and the server linkage device 30 are assumed to be able to perform information processing. Therefore, besides communication components for the server devices 20, the other components can also be specified to be included in this list.) FIG. 5 shows an example of a data configuration of the linkage-pattern-management table 352. As shown in FIG. 5, the linkage-pattern-management 352 stores a component-to-call list 3522, associating it with a service ID 3521. The component-to-call list 3522 lists up component ID(s) of component(s) which should be called with regards to the service identified with the service ID 3521. The component ID included in the component-to-call list 3522, for example, indicates the communication component for one of the client devices 10 included in the above-mentioned channel-to-client unit 310, the communication component for one of the server devices 20 included in the communication-with-server unit 330, or the service-provider component 340.

The server-linkage-processing unit 322 obtains from the linkage-pattern-management table 352 the component-to-call list 3522 corresponding to the service ID determined by the linkage-pattern-determination unit 321, and then calls the components identified with the component IDs included in the obtained component-to-call list 3522. In this process, the server-linkage-processing unit 322 calls the components, passing the information processing request received from the client device 10 as an argument. In addition, the server-linkage-processing unit 322 stores responses from the called components on the memory 32, keeping identification information of the information processing request (This information is hereinafter referred to as request ID.) as a key. After completing calling all of the components corresponding to the component IDs included in the component-to-call list 3522, the server-linkage-processing unit 322 reads out the responses stored on the memory 32, and transfers the read out responses to the linkage-pattern-determination unit 321 as returns.

The linkage-pattern-registration unit 323 accepts inputs regarding to records of the service-mapping table 351 and the linkage-pattern-management table 352, and then registers them on each table. The linkage-pattern-registration unit 323 is made adapted to accept inputs regarding to respective items in those records through the input device 36 such as a keyboard or a mouse. In addition, it is also agreeable to make the linkage-pattern-registration unit 323 adapted to accept inputs of the items by receiving them from the client device 10. The registration process executed by the linkage-pattern-registration unit 323 is described in detail later on.

Meanwhile, the channel-to-client unit 310, the communication components 311 to 315 included in the channel-to-client unit 310, the linkage-pattern-determination unit 321, the server-linkage-processing unit 322, the linkage-pattern-registration unit 323, the communication-with-server unit 330, the communication components 331 to 334 included in the communication-with-server unit 330, and the service-provider component 340 are respectively realized by the CPU 31, equipped with the server linkage device 30, reading out the programs stored on the storage device 33 to the memory 32, and executing the programs. The service-mapping table 351 and the linkage-pattern-management table 352 are realized in storage areas provided by the memory 32 or the storage device 33, equipped with the server linkage device 30.

==Processing by Server Linkage Device 30==

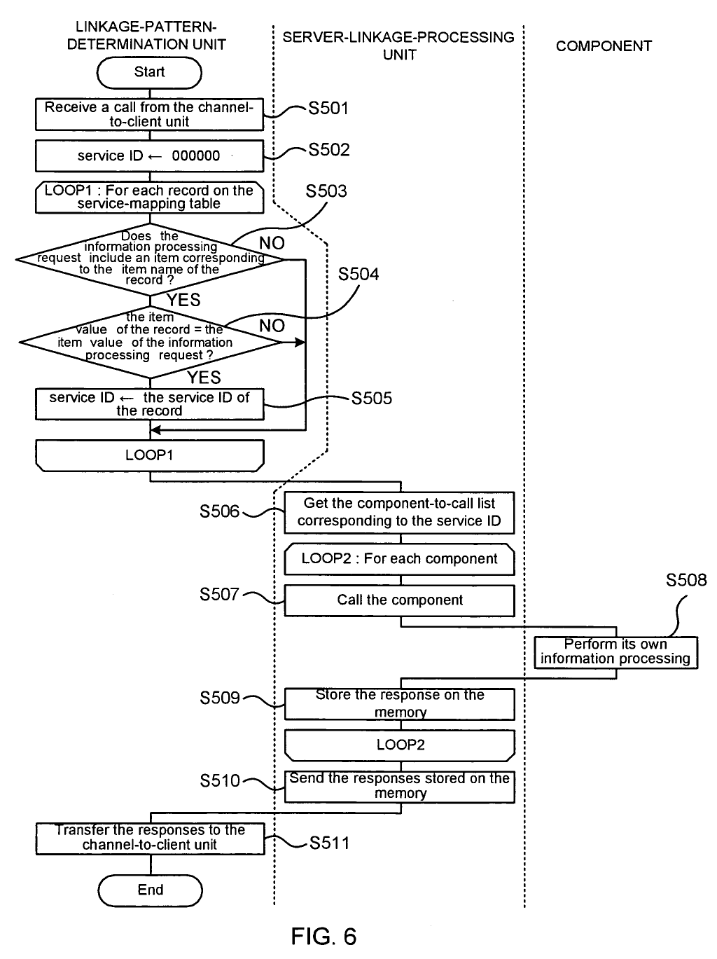

Next, processing by the server linkage device 30 is described. FIG. 6 is a flow chart showing a process executed by the server linkage device 30.

First, the channel-to-client unit 310 receives an information processing request from a client device 10, and calls the linkage-pattern-determination unit 321, passing the received request as an argument (S501). Then, the linkage-pattern-determination unit 321 sets “000000” as the service ID of that request, and carries out the following process for each of the records on the service-mapping table 351.

The linkage-pattern-determination unit 321 finds out if the information processing request includes an item with the same name as the item name 3511 of the record. If so (S503: YES), then the unit 321 finds out if the item value included in that request matches the item value 3512 of that record. If so (S504: YES), then the unit 321 takes a service ID 3513 as the service ID (S505).

The linkage-pattern-determination unit 321 repeats the above process and determines the service ID, and calls the server-linkage-processing unit 322, passing the determined service ID and the information processing request as arguments.

The server-linkage-processing unit 322 obtains the component-to-call list 3522 corresponding to the passed service ID, from the linkage-pattern-management table 352 (S506). Then, the unit 322 calls each of the components identified with the component IDS listed in the component-to-call list 3522, passing the information processing request as an argument (S507).

Each of the components called by the unit 322 performs its own processing (S508). For example, if the component-to-call-list 3522 includes a component ID indicating one of the communication components in the communication-with-server unit 330, then sending the information processing request to the corresponding server device 20 is performed by the communication-with-server unit 330.

After that, the server-linkage-processing unit 322 stores on the memory 32 each of the responses from the called components, keeping the request ID of the information processing request as a key (S509).

The server-linkage-processing unit 322 repeats the above-mentioned process until finishing calling all of the components identified with the component IDS in the component-to-call list 3522. As the next step, the unit 322 reads out the responses from the memory 32 taking the request ID as a key, then sends the read out responses to the linkage-pattern-determination unit 321 (S510). The unit 321 then transfers the received responses to the channel-to-client unit 310 (S511), then the unit 310 transfers them to the corresponding client device 10.

In this way, in the server linkage device 30 of this embodiment, it is possible to analyze an information processing request received from a client device 10 to identify the requested service, and call the appropriate component(s) with which the identified service can be provided. As a result, a client device 10 does not need to understand actual processing required to receive a service, nor know the server devices 20 to which the information processing request should be actually sent; therefore, it becomes easy and simple to develop and manage application programs running on the client devices 10.

In addition, in the server linkage device 30 of this embodiment, a message is analyzed in order to identify the intended service, so that a client device 10 itself does not need to specify the service explicitly. As a result, when using the existing client devices 10, it is not required to make modification to such devices 10 with regards to the format of information processing request, or other formats, and all it takes is just to make the request destination the server linkage device 30; therefore, effective utilization of the existing client devices 10 can be readily realized.

Furthermore, in the server linkage device 30 of this embodiment, a communication component is provided for each server device 20. As a result, even when each server device 20 uses a different protocol from each other, this difference is solved within the communication-with-server unit 330 due to such communication components; therefore, when requiring a plurality of server devices 20, a client device 10 does not need to become aware of the protocols of the server devices 20.

Moreover, when the way of service processing is revised, and the number of steps to provide the service or the content of the processing should be changed, it is not required to modify the application programs running on the client devices 10, so that labor and cost spent for this revision can be largely reduced. Also, it is possible to avoid malfunction that otherwise might be caused with error in modifying the programs running on the client devices 10.

Moreover, in the server linkage device 30 of this embodiment, relations among components called by the server-linkage-processing unit 322 are managed with the linkage-pattern-management table 352, so that components can be loosely coupled. As a result, in the case that a need arises for making some change on the logic in the server linkage device 30, the range affected by this change can be hold as narrow as possible; therefore, such a change on the server linkage device 30 as addition of new features or upgrading, or revision of the processing content or order, can be made with the least trouble.

Moreover, in the server linkage device 30 of this embodiment, responses from respective components corresponding to a service are temporarily stored on the memory, and after a series of information processing regarding to the service are finished, the responses are collectively sent to a client device 10. That is, without transferring a response to a client device 10 every time a server device 20 finishes its own processing, the responses from the server devices 20 can be accumulated on the server linkage device 30. As a result, the load on communication with the client devices 10 can be reduced, and changing the number of data concerning a service can be flexibly handled. For the client side, because responses from several servers are put together into a single response as answer to each request, complicated management of received responses, such as organizing responses for each server, is not required. As a result, if the number of data sent from the server devices 20 as responses is changed, that does not affect application programs running on the client devices 10, and then the relation between application programs on the client devices 10 and on the server devices 20 can be kept as distant as possible; therefore, it is realized to establish such a system as that can embrace specification changes coming under the least influence and trouble.

==Specific Example==

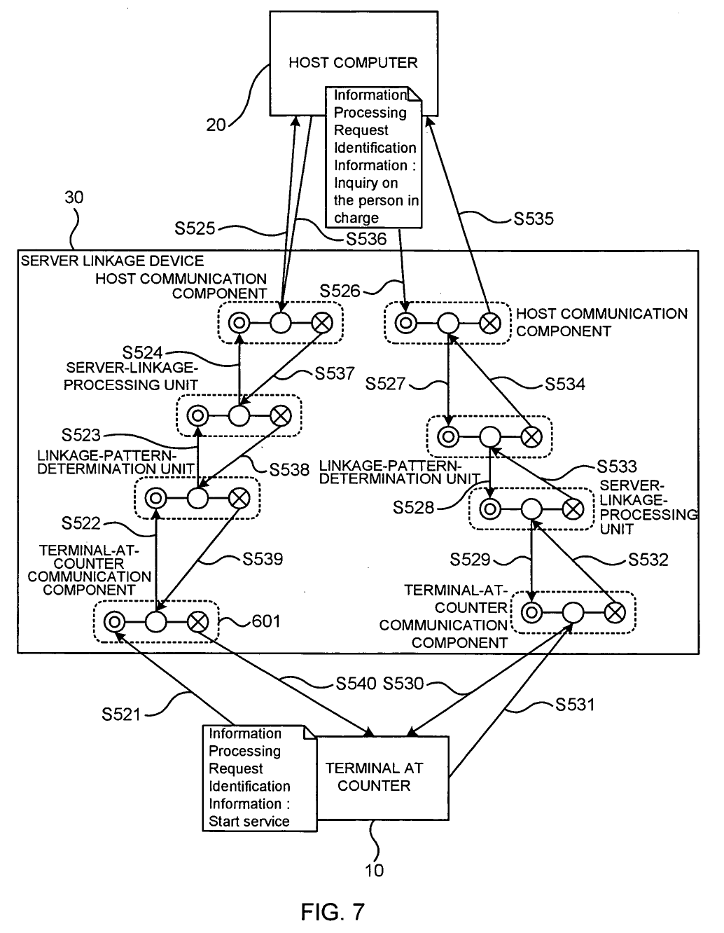

FIG. 7 shows a specific example of the process executed by the server linkage device 30 as mentioned above.

First, a terminal at a counter 10 sends an information processing request which includes “Start service” as the item value of the item name “Identification Information”. Then, in the server linkage device 30, the terminal-at-counter communication component 315 is called (S521), and this component 315 performs the step 601. Here, in FIG. 7, “⊚” stands for a start of a process, “∘” stands for steps of a process, and “∘” including “x” inside stands for an end of a process.

The terminal-at-counter communication component 315 calls the linkage-pattern-determination unit 321, passing the information processing request as an argument (S522). The called unit 321 then performs the steps S501 to S505 in FIG. 6 as described above, and determines the service ID “100100” based on the record with “Start service” as the item value of the item name “Identification Information”, and then calls the server-linkage-processing unit 322, passing the service ID “100100” and the information processing request as arguments (S523).

The unit 322 refers to the component-to-call list 3522 corresponding to the service ID “100100”, then calls the host communication component 331 (S524). The host communication component 331 sends the information processing request to the host computer 20 (S525).

On receiving this request, the host computer 20 sends an information processing request including the item value “Inquiry on the person in charge” of the item name “Identification Information”. Newly the host communication component 331 receives it, then calls the linkage-pattern-determination unit 321, passing the information processing request as an argument (S527). The unit 321, in the same way as described above, determines the service ID “700100” based on the record with “Inquiry on the person in charge” as the item value, and then calls the server-linkage-processing unit 322, passing the determined service ID and the information processing request as arguments (S528). The unit 322 calls the terminal-at-counter communication component 315 corresponding to the service ID “700100”, passing the information processing request as an argument (S529). The called communication component 315 sends the request “Inquiry on the person in change” to the appropriate terminal at a counter 10 (S530). After the terminal at a counter 10 receives the inquiry request and sends the response to that request, the terminal-at-counter communication component 315 transfers it to the server-linkage-processing unit 322 (S532), then the unit 322 transfers it to the linkage-pattern-determination unit 321 (S533), then the unit 321 transfers it to the host communication component 331 (S534), then finally the response reaches the host computer 20 which sent the inquiry request (S535).

Then, the response to the original request “Start service” is issued from the host computer 20 (S536), and is sent to the host communication component 331, then is transferred to the server-linkage-processing unit 322 (S537) to the linkage-pattern-determination unit 321 (S538) to the terminal-at-counter communication component 315 (S539), then eventually reaches the original client device, or the terminal at counter 10 (S540).

As understood from the above-mentioned example, in the server linkage device 30 of this embodiment, for an information processing request issued by a server device 20, the same process is carried out as in the case of a client device 10 issuing a request. That is, a request is analyzed to identify the requested service and the corresponding component is called even for the request from the server side. As a result, a server device 20 can use a service from the other server device 20 without the knowledge on that device 20, so that, it becomes easy for server devices 20 to exchange services with each other; therefore, it becomes possible to manage a complicated logic requiring much information processing as a whole of information processing system.

In addition, in the server linkage device 30 of this embodiment, besides the communication components to communicate with server devices 20, the other components such as the communication components to communicate with client devices 10, and the service-provider component 340 with which the server linkage device 30 can provide its own service, can be registered as components necessary for a service. That is, performers of information processing are not limited to server devices 20. Therefore, information processing for a service can be freely defined with combining various components.

Meanwhile, in the example mentioned above with reference to FIG. 7, a new information processing request is issued by the server device 20, when the original request arrives at the server device 20. Instead of that, it is also possible to make the response from the server device 20 processed, without issuing the new request. In this case, the process shown in FIG. 7 goes on as follows. The host communication component 331 sends the information processing request to the host computer 20 (S525). After that, when the server linkage device 30 receives from the host computer 20 the response to that request, the host communication component 331 calls the linkage-pattern-determination unit 321, passing the response as an argument. Then, if the unit 321 can determine the service ID based on the data item included in the response, the component corresponding to the service ID is called by the server-linkage-processing unit 322. For example, in the case that the response from the host computer 20 includes “Get customer info” as the item value of the item name “Identification Information”, the server linkage device 30, without transferring that response to the client device 10, calls the customer-management-server communication component 334 to obtain the desired information from the customer management server 20.

Therefore, in this case, the volume of communication between the server linkage device 30 and the client device 10 can be reduced, and then jobs for the client device 10 can be reduced by eliminating the process required to receive the response. In addition, when additional process by another server device 20 becomes required for a service device 20 to perform its own processing, because the server linkage device 30 can directly issue a new information processing request to the new added server device 20 without going through a client device 10, there is not raised a need to make any modification to the client side, avoiding malfunction that otherwise might be caused with modifying application programs running on the client devices 10.

==Change of Definition==

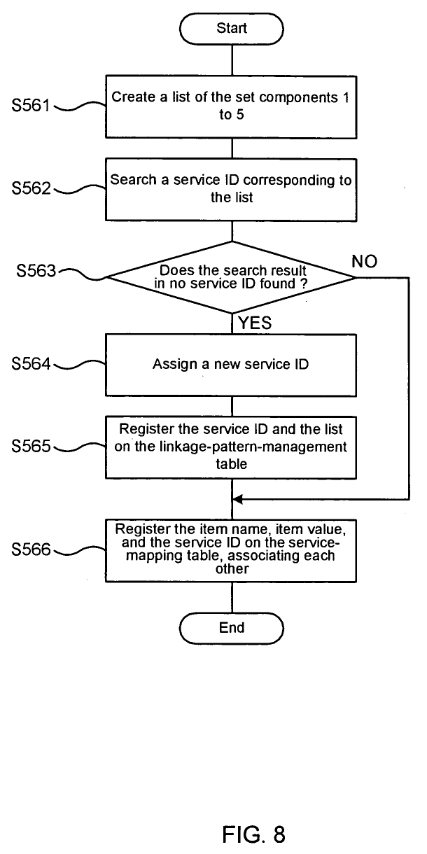

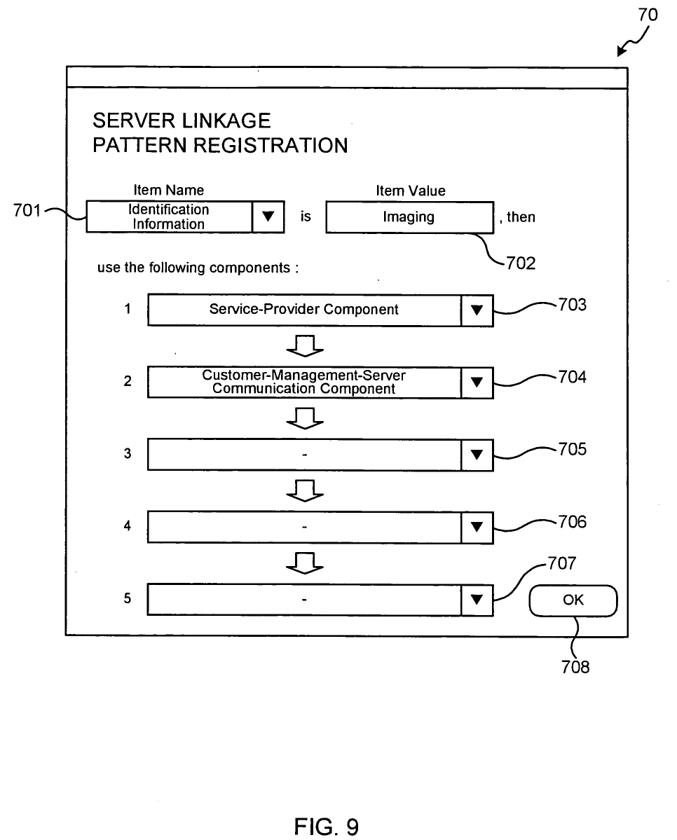

For the function linking a plurality of servers described up until now, the linkage relations among servers are defined with the service-mapping table 351 and the linkage-pattern-management table 352. The contents of both tables can be changed. FIG. 8 is a flow chart showing a process of updating the service-mapping table 351 and the linkage-pattern-management table 352. FIG. 9 shows an example of a screen 70 for use in the updating process illustrated in FIG. 8.

The linkage-pattern-registration unit 323 displays the screen 70. On the screen 70 are an item name field 701 and an item value field 702, which respectively receive entries for the item name 3511 and the item value 3512 of the service-mapping table 351, and component ID list boxes 703 to 707, which respectively receive selections to be set in the component-to-call list 3522 of the linkage-pattern-management table 352. In the example shown in FIG. 9, there are five component ID list boxes provided, but it is also agreeable that the number of the list boxes can be changed according to need. Upon receiving a push on an OK button 708 after the fields and the list boxes are filled in, the linkage-pattern-registration unit 323 creates a list of the component IDs selected in the component ID list boxes 703 to 707 (components 1 to 5)(S561). Then, the unit 323 searches if there is any service ID with the component-to-call list 3522 whose content matches the created-component list (S562). With not finding such a service ID (S563: YES), then the unit 323 generates a new service ID (S564), and then registers the generated service ID and the component list on the linkage-pattern-management table 352 (S565).

The linkage-pattern-registration unit 323 registers the found or generated service ID on the service-mapping table 351, associating the ID with the item name and the item value specified respectively in the item name field 701 and item value field 702 (S566).

In this way, a list of components required to provide a service can be easily registered on the service-mapping table 351 and the linkage-pattern-management table 352.

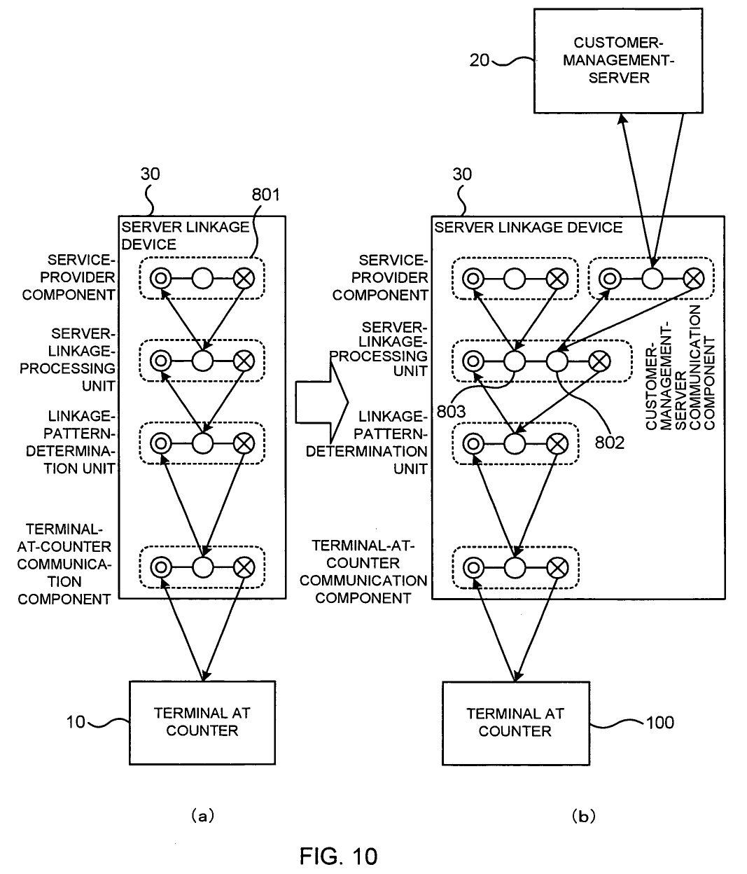

FIG. 10 illustrates a comparison between before-process and after-process when information processing required for a service is changed. FIG. 10 (a) shows a flow of a process regarding to the service of “imaging” with the service ID “400100”. For this service, if an access to the customer management server 20 additionally becomes required, the new component can be set readily as mentioned above. With pushing on the OK button 708 after selecting the service-provider component 340 and the customer-management-server communication component 334 in the component ID list boxes 703 and 704 on the screen 70, a new service ID is assigned, and the list of “the service-provider component, the customer-management-server communication component” is set in the component-to-call list 3522. After this operation, the server-linkage-processing unit 322 comes to call the customer-management-server communication component 334 (802), in addition to calling the service-provider component 340 (803), as shown in FIG. 10 (b).

In this way, in the server linkage device 30 of this embodiment, the number of components called when a service is provided, or the order of call to components can be changed without modifying the application program running on the server linkage device 30. In addition, application programs running on the client devices 10 and the server devices 20 do not have to be modified, either. Therefore, any change such as revising the format of information processing request or a flow of service processing can be flexibly handled. Also, because no need arises for making modification to the existing application programs, it is possible to avoid malfunction that otherwise might be caused with such modification.

Meanwhile, in this embodiment, a communication component is provided for each server device 20, but it is also possible to assign a single communication component to several server devices 20.

In addition, in this embodiment, a new service ID is automatically provided when the linkage-pattern-management table 352 is found not to include a record that matches the list of components selected on the screen 70. However, it is also possible to make a user specify a service ID, and update the component-to-call list 3522 corresponding to the specified service ID.

Having described the embodiment of the present invention, our aim is to facilitate the understanding of the present invention, and the invention should not be construed limited by any of the details of this description. The present invention can be changed and modified without departing from the scope of the claims, and may include equivalents thereof.

What is claimed is:

1. An information processing method, executed by an information processing device which is communicably connected to a client device used by a user, and each of a plurality of server devices to service information processing, the information processing method comprising steps of:
storing, on a memory with regards to each service for each of a series of the information processing required to provide the service, server identification information which is used for identifying the server device to perform the information processing;
receiving a message including service identification information for identifying the service, which is sent from the client device;
identifying the service based on the service identification information included in the received message, and reading out, from the memory, the server identification information corresponding to the identified service; and
sending an information processing request for requesting to perform the information processing, to each of the server devices identified based on the read out server identification information.

2. An information processing method according to claim 1, executed by the information processing device, further comprising steps of:
storing, on the memory, communication information indicating a communication method for use in communication with the server device, with regards to each of the server devices; and
reading out, from the memory, the communication information corresponding to the server device, when sending the information processing request to the server device, and sending the information processing request to the server device following the communication method indicated in the read out communication information.

3. An information processing method according to claim 1, executed by the information processing device, further comprising steps of:
receiving the message which the server device sends upon receiving the information processing request;
reading out, from the memory, the server identification information corresponding to the service identified based on the service identification information included in the received message; and
sending the information processing request to each of the server devices identified based on the read out server identification information.

4. An information processing method according to claim 1, wherein:
the service identification information is a value of a data item that can be included in the message; and
the information processing method, executed by the said information processing device, further comprises steps of:
storing, on the memory, item information indicating the data item, a condition to the value of the data item, and the service, associating each information with the others; and
identifying the service, with regards to the message sent from the client device, based on the condition which corresponds to the item information indicating the data item included in the message and matches the value of the data item, with use of the information stored on the memory.

5. An information processing method according to claim 4, executed by the information processing device, further comprising steps of:
receiving a response message which the server device sends upon receiving the information processing request;
identifying the service based on the condition which corresponds to the item information indicating the data item included in the received response message and matches the value of the data item, with use of the information stored on the memory;
reading out, from the memory, the server identification information corresponding to the identified service; and
sending the information processing request to each of the server devices identified based on the read out server identification information.

6. An information processing method according to claim 1, executed by the information processing device, further comprising steps of:
receiving a plurality of response messages which the respective server devices send as a response upon receiving the information processing request; and
sending the received plurality of response messages to the client device.

7. An information processing method according to claim 1, executed by the information processing device, further comprising steps of:
accepting an input of information processing management data which includes information indicating the processing of the service, and information indicating the server device(s) required to perform the processing; and
storing, on the memory, the information indicating the processing of the service and the information indicating the server device(s) required to perform the processing which are included in the accepted information processing management data, associating each information with the other.

8. An information processing method according to claim 7, executed by the information processing device, further comprising a step of:
accepting the input of the information processing management data, by receiving the information processing management data sent from the client device.

9. An information processing device, which is communicably connected to a client device used by a user and each of a plurality of server devices to perform information processing for a service, comprising:
a server identification information storage unit to store server identification information which is used for identifying the server device to perform the information processing, for each of a series of the information processing required to provide the service, with regards to each of the services;
a message receiving unit to receive a message including service identification information for identifying the service, which is sent from the client device;
a server device identifying unit to read out, from the server identification information storage unit, the server identification information corresponding to the service identified based on the service identification information included in the received message; and
an information processing request sending unit to send an information processing request for requesting to perform the information processing, to each of the server devices identified based on the read out server identification information.

10. An information processing device according to claim 9, further comprising:
a communication information storage unit to store communication information indicating a communication method for use in communication with the server device, with regards to each of the server devices; and
a communication information reading unit to read out, from the communication information storage unit, the communication information corresponding to the server device when sending the information processing request to the server device;
wherein the information processing request sending unit sends the information processing request following the communication method indicated in the read out communication information.

11. An information processing device according to claim 9, wherein:
the information processing device further comprises a response message receiving unit to receive the message which the server device sends upon receiving the information processing request;
the server device identifying unit further reads out, from the server identification information storage unit, the server identification information corresponding to the service identified based on the service identification information included in the received message; and
the information processing request sending unit further sends the information processing request to each of the server devices identified based on the read out server identification information.

12. An information processing device according to claim 9, wherein:
the service identification information is a value of a data item that can be included in the message;
the information processing device further comprises an item information storage unit to store item information indicating the data item, a condition to the value of the data item, and the service, associating each information with the others; and
the server device identifying unit identifies the service, with regards to the message sent from the client device, based on the condition which corresponds to the item information indicating the data item included in the message and matches the value of the data item, with use of the information stored in the item information storage unit.

13. An information processing device according to claim 12, wherein:
the information processing device further comprises a response message receiving unit to receive a response message which the server device sends upon receiving the information processing request;
the server device identifying unit further identifies the service based on the condition which corresponds to the item information indicating the data item included in the received response message and matches the value of the data item, with use of the information stored in the item information storage unit;
the server device identifying unit further reads out, from the server identification information storage unit, the server identification information corresponding to the identified service; and
the information processing request sending unit further sends the information processing request to each of the server devices identified based on the read out server identification information.

14. An information processing device, which is communicably connected to a client device used by a user and each of a plurality of server devices to perform information processing for a service, comprising:
a plurality of communication components to enable communications with the server devices, provided for each of the server devices;
an information processing pattern table to store identification information indicating the communication component corresponding to each of the server devices which perform the information processing, for each of a series of the information processing required to provide the service, with regards to each of the services;
a message receiving unit to receive a message including service identification information for identifying the service, which is sent from the client device;
a message processing unit to identify the service based on the service identification information included in the received message, and read out, from the information processing pattern table, the identification information corresponding to the identified service; and
a distribution processing unit to call each of the communication components identified based on the read out identification information; and
wherein each of the communication components, in responding to the call from the distribution processing unit, sends an information processing request for requesting to perform the information processing, to the corresponding server device.

15. An information processing device according to claim 14, further comprising:
a communication information storage unit to store communication information indicating a communication method for use in communication with the server device, with regards to each of the server devices; and
a communication information reading unit to read out, from the communication information storage unit, the communication information corresponding to the server device when sending the information processing request to the server device;
wherein each of the communication components sends the information processing request following the communication method indicated in the read out communication information.

16. An information processing device according to claim 14, further comprising:
a response message receiving unit to receive a plurality of response messages which the respective server devices send as a response upon receiving the information processing request; and
a response message sending unit to send the received plurality of response messages to the client device.

17. An information processing device according to claim 14, further comprising:
an input accepting unit to accept an input of information processing management data which includes information indicating the processing of the service, and information indicating the server device(s) required to perform the processing; and
an information processing management data storage unit to store the information indicating the processing of the service and the information indicating the server device(s) required to perform the processing which are included in the accepted information processing management data, associating each information with the other.

18. An information processing device according to claim 17, wherein:
the input accepting unit to accept the input of the information processing management data, by receiving the information processing management data sent from the client device.
